(19) United States
(12) Patent Application Publication
(10) Pub. No.: US 2011/0019604 A1
(43) Pub. Date: Jan. 27, 2011

(54) COMMUNICATION METHOD FOR MULTIMEDIA BROADCAST MULTICAST SERVICE(MBMS) COUNTING

(76) Inventors: Sung Duck Chun, Gyeonggi-do (KR); Young Dae Lee, Gyeonggi-do (KR); Seung Jun Yi, Gyeonggi-do (KR); Sung Jun Park, Gyeonggi-do (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/673,741

(22) PCT Filed: Aug. 14, 2008
(86) PCT No.: PCT/KR08/04764

§ 371 Date: Feb. 16, 2010

Related U.S. Application Data
(60) Provisional application No. 60/956,302, filed on Aug. 16, 2007.

(30) Foreign Application Priority Data
Aug. 14, 2008 (KR) 10-2008-0079900

(51) Int. Cl. H04W 40/00

(52) U.S. Cl. 370/312

(57) ABSTRACT

A communication method for performing communication between a specific user equipment and a network to count the number of user equipments, which desire to receive a specific broadcast/multicast service in a mobile communication system, comprises receiving a first message from the network, the first message being transmitted to count the number of user equipments which desire to receive the broadcast/multicast service; and transmitting a second message to the network in response to the first message, the second message being a first layer message or second layer message of the network.

### TECHNICAL FIELD

The present invention relates to a mobile communication system, and more particularly, to a communication method for multimedia broadcast multicast service (MBMS) counting in a mobile communication system.

### BACKGROUND ART

An evolved universal terrestrial radio access network (E-UTRAN) according to an asynchronous mobile communication system standard (3GPP) transmits and provides various data/services. For example, examples of the data/services include system information through a broadcast channel (BCH), a control message through a physical downlink control channel (PDCCH), user traffic or control message through a downlink shared channel (DL SCH) or an uplink shared channel (UL SCH), and an initial uplink control message through a random access channel (RACH).

The MBMS (multimedia broadcast multicast service) is a kind of broadcast/multicast service, and simultaneously transmits data packets to a plurality of user equipments. A broadcast/multicast service used herein can be replaced with other terminologies such as ‘MBMS’ ‘point-to-multipoint service’ and ‘MBS’ (multicast and broadcast service). The MBMS is based on IP multicast, wherein user equipments share resources required for data packet transmission and receive same multimedia data. Accordingly, if a plurality of user equipments, which receive MBMS, exist in the same cell, it is possible to use radio resources efficiently. Since the MBMS is not associated with a RRC connection mode, this service can be provided to even a user equipment which is in an idle mode.

The MBMS includes two types of operation modes, i.e., a broadcast mode and a multicast mode. According to the broadcast mode, one transmitter transmits data to all receivers on a single sub-network. According to the multicast mode, one or more transmitters transmit data to one or more specific receivers. Also, according to the multicast mode, a user equipment should transfer its intention to receive data to a network, and can subscribe to a group and leave from the group.

For effective management of the MBMS, it is necessary to confirm the number of user equipments which desire to receive a specific service. This information can be used to determine an optimized method for broadcast/multicast service. For example, if only a small number of user equipments are interested in the corresponding service, it may be more efficient that a dedicated channel for each user equipment is used to provide the service to each user equipment. On the other hand, if a plurality of user equipments are interested in the corresponding service, it may be more efficient that a common channel is used, wherein the common channel is a point-to-multipoint channel.

A counting method (hereinafter, referred to as ‘MBMS counting’) of user equipments, which desire to receive a specific broadcast/multicast service, starts as a network transmits an access information message to the user equipments through an MBMS control channel (MCCH). If a user equipment which desires to receive the broadcast/multicast service is in an RRC connection state, counting can be performed using a dedicated channel or a RACH. By contrast, if the user equipment which desires to receive the broadcast/multicast service is in an idle state, the user equipment transmits an RRC connection request message to the network according to a random access procedure using the RACH.

Hereinafter, the RACH and the random access procedure in a WCDMA system will be described. The RACH is used to transmit data having a short length in an uplink. Some RRC messages such as RRC connection request message, a cell update message, and URA update message are transmitted through the RACH. Logical channels, i.e., common control channel (CCCH), a dedicated control channel (DCCH), and a dedicated traffic channel (DTCH) can be mapped to the RACH which is a transport channel. The RACH can be mapped to a PRACH which is a physical channel.

If a medium access control (MAC) layer of the user equipment commands its physical layer to transmit the PRACH, the physical layer of the user equipment selects one access slot and one signature and transmits a PRACH preamble in the uplink. The preamble is transmitted for a period of the access slot having a 1.33 ms length, and one signature among signatures is selected and transmitted for a first certain length of the access slot. If the user equipment transmits the preamble, the base station transmits a response signal through an acquisition indicator channel (AICH) which is a downlink physical channel. The AICH transmitted in response to the preamble transmits the signature selected by the user equipment for a first certain period of an access slot corresponding to the access slot for which the preamble is transmitted. At this time, the base station transmits a positive acknowledgement (ACK) or a negative acknowledgement (NACK) using the signature transmitted through the AICH. If the user equipment receives a ACK, the user equipment transmits RRC connection request message to the network using allocated radio resources. Then, the network transmits a contention resolution message and a RRC connection setup message to the user equipment. If the user equipment receives a NACK, the MAC layer of the user equipment again commands the physical layer of the user equipment to transmit the PRACH after a certain amount of time. Meanwhile, if the user equipment does not receive the AICH corresponding to the transmitted preamble, the user equipment transmits a new preamble at a power higher than that of the previous preamble by one level after a given access slot.

### DETAILED DESCRIPTION OF THE INVENTION

### Technical Problems

According to the related art, in order to count the number of user equipments which desire to receive a broadcast/multicast service, a network transmits a RRC access information message for counting in downlink, and a user equipment transmits a RRC connection request message or a RRC cell update message for counting response. In this case, a problem occurs in that uplink radio resources are consumed during counting procedure since RRC messages having large overhead are used for counting response.

Accordingly, the present invention is directed to a communication method for multimedia broadcast multicast service (MBMS) counting, which substantially obviates one or more problems due to limitations and disadvantages of the related art.

An object of the present invention is to provide a communication method for multimedia broadcast multicast service (MBMS) counting in a mobile communication system, in which overhead and resource waste do not occur during counting procedure of a broadcast/multicast service.

Another object of the present invention is to provide a communication method for multimedia broadcast multicast service (MBMS) counting in a mobile communication system, in which a message having little overhead as compared with the RRC message is used as a response message during counting.

Other object of the present invention is to provide a communication method for multimedia broadcast multicast service (MBMS) counting in a mobile communication system, in which communication related to counting response is performed through an uplink radio resources previously allocated to a user equipment which desires to receive the service.

### Technical Solutions

To achieve these objects and other advantages and in accordance with the purpose of the invention, as embodied and broadly described herein, there is provided a communication method for performing communication between a specific user equipment and a network to count the number of user equipments which desire to receive a specific broadcast/multicast service in a mobile communication system.

According to the embodiment of the present invention, a response message for counting is a lower layer message of an RRC layer not an RRC message during counting procedure related to a broadcast/multicast service. Preferably, the message is a first layer message and/or second layer message of a network.

Accordingly, in one aspect of the present invention, a communication method for performing communication between a specific user equipment and a network to count the number of user equipments, which desire to receive a specific broadcast/multicast service in a mobile communication system, comprises receiving a first message from the network, the first message being transmitted to count the number of user equipments which desire to receive the broadcast/multicast service; and transmitting a second message to the network in response to the first message, the second message being a first layer message or second layer message of the network.

In another aspect of the present invention, a communication method for performing communication in a network of a mobile communication system to count the number of user equipments, which desire to receive a specific broadcast/multicast service, comprises transmitting a first message to at least one user equipment, the first message being transmitted to count the number of user equipments which desire to receive the broadcast/multicast service; and receiving a second message from the user equipment in response to the first message, the second message being a first layer message or second layer message of the network.

### ADVANTAGEOUS EFFECTS

According to the embodiments of the present invention, the following advantages can be obtained.

First of all, overhead and resource waste, which may occur during counting procedure of a broadcast/multicast service, can be resolved.

Second, a message having little overhead as compared with a RRC message can be used as a response message during counting procedure.

Finally, communication for the counting response can be performed using uplink radio resources previously allocated to a user equipment which desires to receive the broadcast/multicast service.

### BRIEF DESCRIPTION OF THE DRAWINGS

FIG. 1 is a diagram illustrating a network structure of an E-UMTS (Evolved-Universal Mobile Telecommunications System);

FIG. 2 is a schematic view illustrating an E-UTRAN (Evolved Universal Terrestrial Radio Access Network);

FIG. 3 is a diagram illustrating a structure of a radio interface protocol between a user equipment (UE) and E-UTRAN;

FIG. 4 is a diagram illustrating an example of a physical channel used in E-UMTS;

FIG. 5 is a flow chart illustrating a procedure according to the embodiment of the present invention; and

FIG. 6 is a diagram illustrating a structure of MAC PDU according to the embodiment of the present invention.

### BEST MODE FOR CARRYING OUT THE INVENTION

Hereinafter, structures, operations, and other features of the present invention will be understood readily by the preferred embodiments of the present invention, examples of which are illustrated in the accompanying drawings. Embodiments described later are examples in which technical features of the present invention are applied to E-UMTS (Evolved Universal Mobile Telecommunications System).

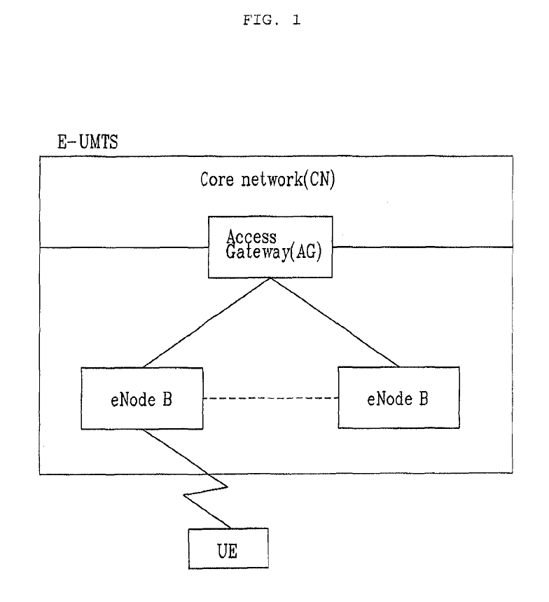

FIG. 1 illustrates a network structure of an E-UMTS to which the embodiment of the present invention is applied. An E-UMTS is a system evolving from the conventional WCDMA UMTS and its basic standardization is currently handled by the 3GPP (3^{rd} Generation Partnership Project). The E-UMTS can also be called an LTE (Long Term Evolution) system. Release 7 and Release 8 of 3GPP technical specifications (3^{rd} Generation Partnership Project; Technical Specification Group Radio Access Network) can be referred to obtain detailed information about the UMTS and E-UMTS.

Referring to FIG. 1, an E-UMTS includes a user equipment (UE), a base station and an access gateway (AG), wherein the access gateway is connected to an external network by being located at an end of the base station. Generally, the base station can simultaneously transmit multiple data streams for broadcast service, multicast service and/or unicast service. The AG may be classified into a part for handling user traffic and a part for handling control traffic. At this time, an AG for handling user traffic may communicate with another AG for handling control traffic via a new interface. At least one cell exists in one eNB. An interface for transmitting user traffic or control traffic may be used between eNBs. A core network (CN) can include the AG and a network node for registering users of User Equipments (UEs). An interface for discriminating between the E-UTRAN and the CN may also be used. The AG manages mobility of a UE by unit of a tracking area (TA). The TA comprises a plurality of cells. When a user equipment moves into a specific tracking area (TA) from another tracking area (TA), the user equipment informs the AG that its tracking area has been changed.

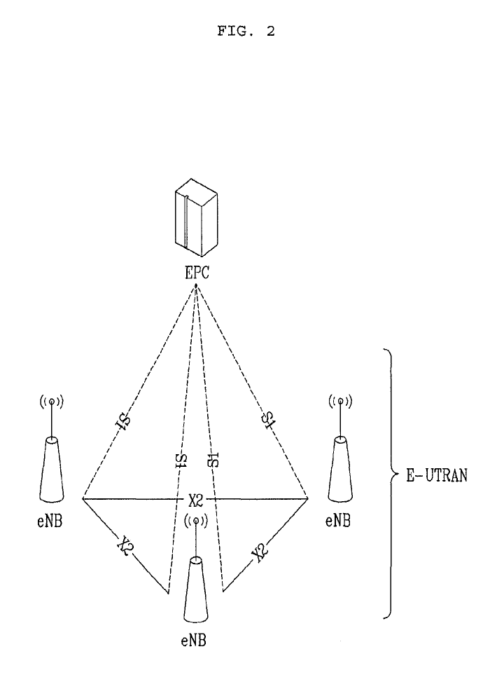

FIG. 2 is a schematic view illustrating a network structure of an E-UTRAN (UMTS terrestrial radio access network) to which the embodiment of the present invention is applied. The E-UTRAN system is a system evolving from the conventional UTRAN system. The E-UTRAN includes base stations (eNBs), wherein respective eNBs are connected with each other through a X2 interface. Also, each of eNBs is connected with a user equipment (UE) through a radio interface and connected with an EPC (Evolved Packet Core) through a S1 interface.

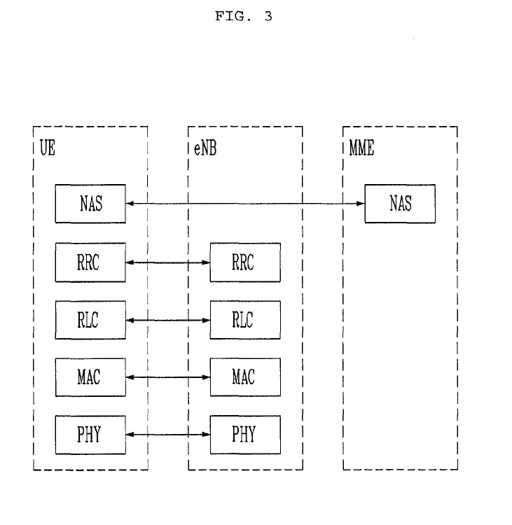

FIG. 3 is a diagram illustrating a structure of a radio interface protocol between the user equipment (UE) and the E-UTRAN, based on the 3GPP radio access network standard. Referring to FIG. 3, a radio interface protocol horizontally includes a physical layer, a data link layer, and a network layer, and vertically includes a user plane for data information transfer and a control plane for signaling transfer. The protocol layers of FIG. 2 can be classified into L1 (first layer), L2 (second layer), and L3 (third layer) based on three lower layers of the open system interconnection (OSI) standard model widely known in the communications systems.

The physical layer as the first layer provides information transfer service to an upper layer using physical channels. The physical layer (PHY) is connected to a medium access control (hereinafter, abbreviated as ‘MAC’) layer above the physical layer via transport channels. Data is transferred between the medium access control layer and the physical layer via the transport channels. Moreover, data is transferred between different physical layers, and more particularly, between one physical layer of a transmitting side and the other physical layer of a receiving side via the physical channels. The physical channel of the E-UMTS is modulated in accordance with an orthogonal frequency division multiplexing (OFDM) scheme, and time and frequency are used as radio resources.

The medium access control (hereinafter, abbreviated as ‘MAC’) layer of the second layer provides a service to a radio link control (hereinafter, abbreviated as ‘RLC’) layer above the MAC layer via logical channels. The RLC layer of the second layer supports reliable data transmission. In order to effectively transmit IP packets (e.g., IPv4 or IPv6) in a radio interface having a relatively narrow bandwidth, a PDCP layer of the second layer (L2) performs header compression to reduce unnecessary control information.

A radio resource control (hereinafter, abbreviated as ‘RRC’) layer located on a lowest part of the third layer is defined in the control plane only and is associated with configuration, reconfiguration and release of radio bearers (hereinafter, abbreviated as ‘RBs’) in charge of controlling the logical, transport and physical channels. In this case, the RB means a service provided by the second layer for the data transfer between the UE and the UTRAN. To this end, the RRC layer allows messages to be exchanged between the user equipment and the network. If the RRC layer of the user equipment is connected with the RRC layer of the network, the user equipment is in an RRC connected mode. If not so, the user equipment is in an RRC idle mode.

A non-access stratum (NAS) layer located above the RRC layer performs session management and mobility management.

One cell constituting eNB is set with one of bandwidths of 1.25 Mhz, 2.5 Mhz, 5 Mhz, 10 Mhz and 20 Mhz, and provides downlink or uplink transfer service to several user equipments. At this time, different cells can be set to have different bandwidths.

As downlink transport channels carrying data from the network to the UE, there are provided a broadcast channel (BCH) carrying system information, a paging channel (PCH) carrying a paging message, and a downlink shared channel (DL SCH) carrying user traffic or control messages. The traffic or control messages of a downlink multicast or broadcast service can be transmitted via the downlink SCH or an additional downlink multicast channel (MCH). Meanwhile, as uplink transport channels carrying data from the UE to the network, there are provided a random access channel (RACH) carrying an initial control message and an uplink shared channel (UL-SCH) carrying user traffic or control message.

As logical channels located above the transport channels and mapped with the transport channels, there are provided a broadcast control channel (BCCH), a paging control channel (PCCH), a common control channel (CCCH), a multicast control channel (MCCH), and a multicast traffic channel (MTCH).

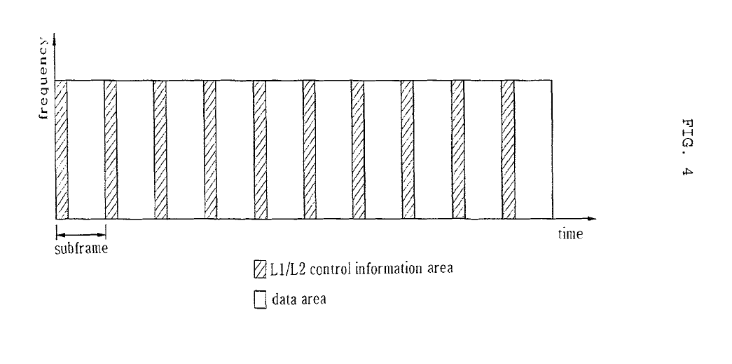

FIG. 4 is a diagram illustrating an example of a physical channel used in the E-UMTS. A physical channel includes a plurality of sub-frames on a time axis and a plurality of sub-carriers on a frequency axis, wherein one sub-frame includes a plurality of symbols on the time axis. One sub-frame includes a plurality of resource blocks, each of which includes a plurality of symbols and a plurality of sub-carriers. Also, each sub-frame can use specific sub-carriers of specific symbols (for example, first symbols) for a physical downlink control channel (PDCCH), i.e., L1/L2 control channel. L1/L2 control information transmission region (hatching part) and a data transmission region (non-hatching part) are shown in FIG. 4. The evolved universal mobile telecommunications system (E-UMTS) which is currently being discussed uses a radio frame of 10 ms, wherein one radio frame comprises 10 sub-frames. Also, one sub-frame comprises two continuous slots. One slot has a length of 0.5 ms. Furthermore, one sub-frame comprises a plurality of OFDM symbols, and a part (for example, first symbol) of the plurality of OFDM symbols can be used to transmit L1/L2 control information.

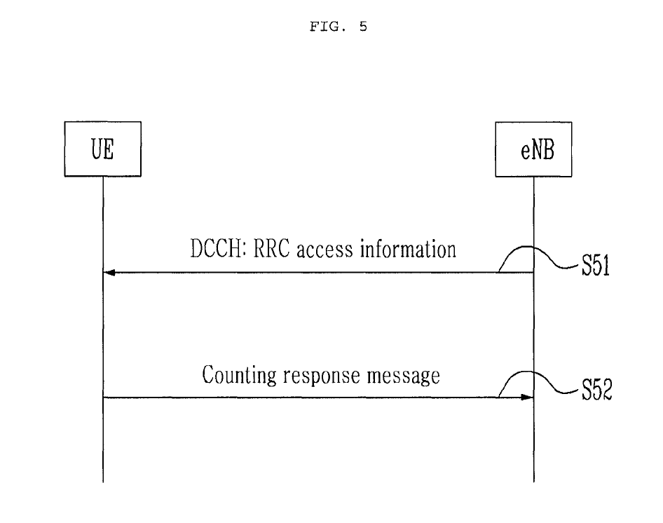

FIG. 5 is a flow chart illustrating a procedure according to the embodiment of the present invention. Namely, FIG. 5 illustrates an example in which technical features of the present invention are applied to user equipment which joins MBMS counting.

Referring to FIG. 5, the base station transmits a first message for counting a user equipment, which desires to receive a specific broadcast/multicast service, to the user equipment, thereby providing the specific broadcast/multicast service [S51]. The MBMS counting is initiated by the first message.

A method for resolving overhead caused by MBMS counting procedure in accordance with the embodiment of the present invention can be implemented variously depending on the states of the user equipment. Accordingly, there is no specific limitation of the states of the user equipment which receives the first message. However, before the step S51, i.e., before receiving the first message, uplink radio resources may be allocated from the base station to the user equipment. For example, the user equipment may be in a CELL-DCH state. The uplink radio resources allocated to the user equipment could be an uplink shared channel (UL SCH) or an uplink dedicated channel (PUCCH, physical scheduling channel, etc.). Preferably, the uplink radio resources comprise an uplink dedicated channel.

Furthermore, if the user equipment desires to receive a broadcast/multicast service, there may be no uplink radio resources previously allocated to the user equipment. For example, the user equipment could be in an idle mode, CELL-FACH mode, CELL_PCH mode, and URA_PCH mode. In this case, the user equipment can join the MBMS counting by receiving the first message after being allocated with the uplink radio resources in accordance with a general procedure. Alternatively, the user equipment may be on standby without being allocated with the uplink radio resources until it receives the first message. Namely, the user equipment can be allocated with the uplink radio resources through a general procedure, for example, a random access procedure, after receiving the first message.

According to the above procedure, the user equipment, which desires to receive a specific broadcast/multicast service, can be categorized as following cases.

(1) If there already exist allocated uplink radio resources: joining MEMS counting.

(2) If there are no allocated uplink radio resources:
(2-i) uplink radio resources are allocated from the base station in accordance with a general procedure before MBMS counting is initiated.
(2-ii) uplink radio resources are allocated from the base station in accordance with a random access procedure after MBMS counting is initiated.
   The above cases (2-i) and (2-ii) can be determined adaptively in accordance with a radio environment. For example, if there is a room for uplink radio resources, (2-i) may be preferred for fast and exact counting. If not so, (2-ii) may be preferred. Also, there may be combination of (2-i) and (2-ii). Accordingly, user equipments which join MEMS counting could be, for example, (1) and (2-i); (1) and (2-ii); (1), (2-i) and (2-ii). Preferably, the user equipments which join MBMS counting are (1) and (2-i).

The first message initiating MBMS counting could be a RRC message or a MAC control element. Preferably, the first message could be a RRC access information message. The first message can include an user equipment identifier for identifying an user equipment and/or a service identifier allocated by a CN or a RRC layer of the base station to identify a corresponding broadcast/multicast service. The service identifier could be a MTCH RNTI (Radio Network Temporary Identity) of a MTCH RNTI or a MBMS RNTI. Also, the first message can further include a separate counting indicator indicating MBMS counting. The counting indicator could be a specific bit or bit stream. The counting indicator could be a specific bit indicating ‘0’ or ‘1’. For example, the counting indicator could be an original specific bit or bit stream constituting the first message. In this case, the specific bit can perform a counting indicating function for MBMS counting together with its original function or regardless of its original function. For example, a part of the first message, which is not associated with MBMS counting, can be dedicated as a counting indicator, or some bits of a part associated with MBMS counting can be used as a counting indicator. Also, the counting indicator could be different from an original bit or bit stream constituting the first message. In this case, the bit or bit stream can be set in a field, which is not associated with MBMS counting, or a field newly added to the first message, among fields constituting the first message. The counting indicator is a terminology randomly defined to describe the embodiment of the present invention and may be designated as other equivalent terminologies.

Preferably, the first message can include information indicating a specific time interval within which a response of a user equipment to the first message should be transmitted. By defining the time interval, overhead, time delay, etc., which may occur during MBMS counting, can effectively be resolved. Details of the time interval will be described later with reference to a second message.

If uplink radio resources are allocated to the user equipment, the first message can be transmitted through a DCCH (Dedicated Control Channel). Also, the first message can be transmitted through a MCCH or a PDCCH. If the first message is transmitted through the PDCCH, the base station transmits the service identifier and the counting indicator together or separately. Even though the first message is exemplified to be transmitted via a DCCH only, it is to be understood that this is only exemplary, and the first message may be transmitted to the MCCH or the PDCCH.

If the first message is successfully received by the user equipment and includes a user equipment identifier of the user equipment or a service identifier of a desired service, the user equipment transmits a second message in response to the first message so as to join MBMS counting [S52]. In order to resolve overhead and resource waste due to use of the RRC message, the second message is a first layer (physical layer) message or a second layer (radio data link layer) message of the base station.

The second message can include at least one of a counting response indicator indicating that the second message is a response of the first message, a user equipment identifier and a service identifier. The counting response indicator could be a specific bit or bit stream. The counting response indicator could be a specific bit indicating ‘0’ or ‘1’. For example, the counting response indicator could be an original specific bit or bit stream constituting the second message. In this case, the specific bit or bit stream can perform a counting response function for MBMS counting together with its original function or regardless of its original function. For example, a part of the second message, which is not associated with MBMS counting, can be dedicated as a counting indicator, or some bits of a part associated with MBMS counting can be used as a counting response indicator. Also, the counting response indicator could be different from an original bit or bit stream, which constitutes the second message. In this case, the bit or bit stream can be set in a field, which is not associated with MBMS counting, or a field newly added to the second message, among fields constituting the second message. The counting response indicator is a terminology randomly defined to describe the embodiment of the present invention and may be designated as other equivalent terminologies.

According to the embodiment of the present invention, a method for using the first layer message or second layer message of the base station as the second message can be classified depending on that information of a specific time interval is included in the first message. Hereinafter, the method will be described in detail.

First, if information of the specific time interval within which the second message will be transmitted is included in the first message, the user equipment transmits the second message to the base station for the specific time interval only. The second message transmitted for the time interval could be a message originally used for MBMS counting or another message for other purpose of use. In latter case, the base station can interpret the message transmitted for the specific time interval as a response to MBMS counting. In other words, a bit, bit stream, bit command or parameter of an uplink message for other purpose of use (for example, scheduling request) can be interpreted as a response to counting for the specific time interval. Namely, a specific bit, bit stream, bit command or specific parameter of the uplink message transmitted for the specific time interval can be interpreted as a counting response indicator indicating a response to the first message regardless of its original function. For example, if the user equipment transmits scheduling request information through a physical scheduling channel, the base station interprets the scheduling request information received for the specific time interval as the response to the MBMS counting. On the other hand, if the base station receives scheduling request information for a time interval other than the specific time interval, the base station performs an original scheduling procedure.

Furthermore, MAC layer message, for example, a specific bit of a MAC header or a MACH control element can be used as the response to the MBMS counting for the specific time interval. For example, although a message for buffer status reporting is used for buffer status reporting for a certain time interval other than the specific time interval, the message can be used as the response to the MBMS counting for the specific time interval. However, the message is not used for buffer status reporting for the specific time interval. Preferably, the message transmitted for the specific time interval is a physical layer signal.

If the information of the specific time interval within which the response to the MBMS counting will be transmitted is included in the first message, it is sufficient to notice the physical layer for the specific time interval only, in order to identify the presence of counting response. Accordingly, the base station can quickly identify the response to the MBMS counting. Preferably, the uplink radio resources established for the user equipment comprise an uplink physical channel dedicated to the user equipment. More preferably, the uplink radio resources established for the user equipment is a PUCCH or a physical scheduling channel.

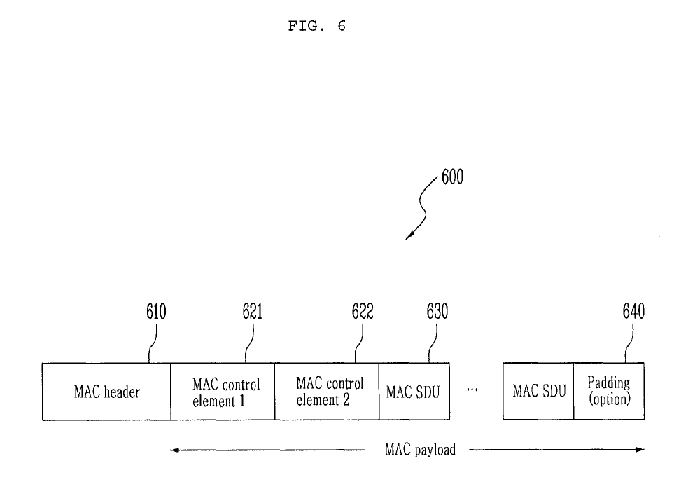

Also, if the information of the specific time interval within which the second message will be transmitted is not included in the first message, the user equipment can use the second layer message of the base station, preferably, a MAC layer message as the second message. Hereinafter, the embodiment in which the MAC layer message is used will be described with reference to FIG. 6.

FIG. 6 is a diagram illustrating a structure of MAC PDU according to the embodiment of the present invention.

Referring to FIG. 6, the MAC PDU 600 includes a MAC header 610, MAC control elements 621 and 622, and MAC SDU 630. Also, the MAC PDU 600 optionally includes padding 640. The other parts except for the MAC header 610 constitute MAC payload. Although the MAC control elements 621 and 622 and the MAC SDU 630 are illustrated in FIG. 6, they may not be included in the MAC PDU 600, or a plurality of MAC control elements and MAC SDUs may be included therein. If a plurality of MAC control elements 621 and 622 or a plurality of MAC SDUs 630 are included in the MAC PDU 600, the MAC header 610 can include a plurality of MAC PDU subheaders corresponding to the MAC control elements and MAC SDUs. The MAC PDU subheaders are not shown. The MAC PDU subheaders can be comprised of R/R/E/LCID fields or R/R/E/LCID/F/L fields. In this case, R represents reserved bits, E represents an extension field, LCID represents a logical channel ID field, L represents a length field, and F represents a format field. The MAC control elements 621 and 622 can include buffer status report MAC control element, C-RNTI MAC control element, DRX command MAC control element, UE contention resolution identity MAC control element, timing advance MAC control element, and power headroom MAC control element.

According to the embodiment of the present invention, the user equipment can include, in the MAC header 610, at least one of the counting response indicator, the user equipment identifier and the service identifier, and can transmit the MAC PDU 600 to the base station. For example, at least one of the counting response indicator, the user equipment identifier and the service identifier is included in at least one of the R/R/E/LCID/F/L fields constituting the MAC header 610. In this case, the information of counting response can be included in the field continuously or separately. Also, the information of counting response may be included in a new field added to the R/R/E/LCID or R/R/E/LCID/F/L fields.

Furthermore, the user equipment can include at least one of the counting response indicator, the user equipment identifier, and the service identifier in the MAC control elements 621 and 622, and can transmit the MAC PDU 600 for uplink transmission to the base station, wherein the MAC PDU 600 includes the MAC control elements 611 and 612. For example, the information of counting response can be included in at least one of buffer status report MAC control element, C-RNTI MAC control element, DRX command MAC control element, UE contention resolution identity MAC control element, timing advance MAC control element, and power headroom MAC control element. The information of counting response can be included in one MAC control element or several MAC control elements.

Furthermore, although it has been exemplarily described that at least one of the counting response indicator, the user equipment identifier and the service identifier is included in any one of the MAC control elements 621 and 622 or the MAC header 610, the at least one may be included in the MAC header 610 and the MAC control elements 621 and 622, simultaneously. The uplink radio resources established for the user equipment could be an uplink physical channel dedicated to the user equipment or a shared channel with another user equipment. Preferably, the uplink radio resources comprise a shared channel, more preferably, UL SCH.

Furthermore, if the uplink radio resources allocated to the user equipment is a radio resources of the UL SCH, the user equipment can include, in the MAC control elements, at least one of the counting response indicator, the user equipment identifier and the service identifier, and can transmit the MAC control elements to the UL SCH, wherein the MAC control elements are included in the MAC PDU for uplink transmission.

Moreover, if HARQ is used, the user equipment can retransmit the second message at least twice or more within the maximum retransmission count of HARQ. In this case, the base station may not transmit HARQ ACK or NACK with respect to the second message.

The second message can be transferred to the RRC layer directly after it is received in the first layer and/or the second layer. Also, additional information required for MBMS counting, control information, and counting information related to change of an inner setup value can additionally be interpreted in a physical layer (first layer) or a data link layer (second layer). In this case, the interpreted counting information is transmitted to the upper layer of the first and second layers of the base station, preferably, to the RRC layer. In other words, although information of MBMS counting is finally transmitted to the RRC layer, the response message to the MBMS counting, which is transmitted from the user equipment, is a message of the first layer or the second layer, which is a lower layer, and thus overhead related to the MBMS counting and waste of uplink radio resources can be resolved and fast MBMS counting can be performed.

The aforementioned embodiments are achieved by combination of structural elements and features of the present invention in a predetermined type. Each of the structural elements or features should be considered selectively unless specified separately. Each of the structural elements or features may be carried out without being combined with other structural elements or features. Also, some structural elements and/or features may be combined with one another to constitute the embodiments of the present invention. The order of operations described in the embodiments of the present invention may be changed. Some structural elements or features of one embodiment may be included in another embodiment, or may be replaced with corresponding structural elements or features of another embodiment. Moreover, it will be apparent that some claims referring to specific claims may be combined with another claims referring to the other claims other than the specific claims to constitute the embodiment or add new claims by means of amendment after the application is filed.

The embodiments of the present invention have been described based on the data transmission and reception between the base station and the user equipment. A specific operation which has been described as being performed by the base station may be performed by an upper node of the base station as the case may be. In other words, it will be apparent that various operations performed for communication with the user equipment in the network which includes a plurality of network nodes along with the base station can be performed by the base station or network nodes other than the base station. The base station may be replaced with terms such as a fixed station, Node B, eNode B (eNB), and access point.

The embodiments according to the present invention may be implemented by various means, for example, hardware, firmware, software, or their combination. If the embodiment according to the present invention is implemented by hardware, the random access method in the wireless communication system according to the embodiment of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the method of processing data in a wireless communication system according to the embodiment of the present invention may be implemented by a type of a module, a procedure, or a function, which performs functions or operations described as above. A software code may be stored in a memory unit and then may be driven by a processor. The memory unit may be located inside or outside the processor to transmit and receive data to and from the processor through various means which are well known.

It will be apparent to those skilled in the art that the present invention can be embodied in other specific forms without departing from the spirit and essential characteristics of the invention. Thus, the above embodiments are to be considered in all respects as illustrative and not restrictive. The scope of the invention should be determined by reasonable interpretation of the appended claims and all change which comes within the equivalent scope of the invention are included in the scope of the invention.

### INDUSTRIAL APPLICABILITY

The aforementioned embodiments and advantages are illustrative, and should not be interpreted as limiting the present invention. The technical spirits disclosed in this specification can easily be applied to other types of apparatuses.

The detailed description of the present invention is intended to describe the present invention, and does not limit the scope of claims. It will be apparent to those skilled in the art that various replacements, corrections and modifications can be made in the present invention. The scope of means-plus-function clauses in claims will reach structural equivalents or equivalent structures in addition to the structure for the functions disclosed in this specification.

What is claimed is:

1. A communication method for performing communication between a specific user equipment and a network to count a number of user equipments which desire to receive a specific broadcast/multicast service in a mobile communication system, the communication method comprising:
receiving a first message from the network, the first message being transmitted to count a number of user equipments which desire to receive the broadcast/multicast service; and
transmitting a second message to the network in response to the first message, the second message being a first layer message or second layer message of the network.

2. The communication method as claimed in claim 1, wherein uplink radio resources are allocated to the user equipment before the first message is received.

3. The communication method as claimed in claim 2, wherein the uplink radio resources comprise an uplink physical channel dedicated to the user equipment.

4. The communication method as claimed in claim 1, further comprising performing a random access procedure to be allocated with uplink radio resources if there is no uplink radio resources allocated to the user equipment.

5. The communication method as claimed in claim 1, wherein the first message includes at least one of a user equipment identifier identifying the user equipment and a service identifier identifying the broadcast/multicast service.

6. The communication method as claimed in claim 1, wherein the first message includes a counting indicator indicating that the first message is to count the number of user equipments which desire to receive the broadcast/multicast service.

7. The communication method as claimed in claim 1, wherein the first message includes information indicating a specific time interval within which the second message should be transmitted.

8. The communication method as claimed in claim 1, wherein the second message includes at least one of a counting response indicator indicating that the second message is a response to the first message, the user equipment identifier, and the service identifier.

9. The communication method as claimed in claim 1, wherein the second message is included in a header of a MAC PDU (medium access control protocol data unit) or a MAC control element, or is a physical layer signal.

10. The communication method as claimed in claim 7, wherein the second message is transmitted for the indicated specific time interval only.

11. A communication method for performing communication in a network of a mobile communication system to count a number of user equipments which desire to receive a specific broadcast/multicast service, the communication method comprising:
transmitting a first message to at least one user equipment, the first message being transmitted to count a number of user equipments which desire to receive the broadcast/multicast service; and
receiving a second message from the user equipment in response to the first message, the second message being a first layer message or second layer message of the network.

12. The communication method as claimed in claim 11, further comprising transferring the second message to a RRC (radio resource control) layer of the network.

13. The communication method as claimed in claim 11, wherein uplink radio resources are allocated to the user equipment before the first message is transmitted.

14. The communication method as claimed in claim 13, wherein the uplink radio resources comprises an uplink physical channel dedicated to the user equipment.

15. The communication method as claimed in claim 11, further comprising allocating uplink radio resources to the user equipment through a random access procedure if there is no uplink radio resources allocated to the user equipment.

16. The communication method as claimed in claim 11, wherein the first message includes at least one of a user equipment identifier identifying the user equipment and a service identifier identifying the broadcast/multicast service.

17. The communication method as claimed in claim 11, wherein the first message includes a counting indicator indicating that the first message is to count the number of user equipments which desire to receive the broadcast/multicast service.

18. The communication method as claimed in claim 11, wherein the first message includes information indicating a specific time interval within which the second message should be transmitted.

19. The communication method as claimed in claim 11, wherein the second message includes at least one of a counting response indicator indicating that the second message is a response to the first message, the user equipment identifier, and the service identifier.

20. The communication method as claimed in claim 11, wherein the second message is included in a header of MAC PDU (medium access control protocol data unit) or a MAC control element, or is a physical layer signal.

21. The communication method as claimed in claim 18, wherein the second message is transmitted for the indicated specific time interval only.
